(19) United States
(12) Patent Application Publication
(10) Pub. No.: US 2009/0019385 A1
(43) Pub. Date: Jan. 15, 2009

(54) Management of Icons in a Display Interface

(75) Inventors: Imtiyaz Altafhussain Khatib, Pune (IN); Saandiip Gajanan Padte, Pune (IN); Amruta Satish Lonkar, Pune (IN); Avinash Dattatraya Jagtap, Pune (IN); Swati Narendra Sadineni, Pune (IN)

Correspondence Address: NVIDIA C/O MURABITO, HAO & BARNES LLP, TWO NORTH MARKET STREET, THIRD FLOOR, SAN JOSE, CA, 95113, US

(73) Assignee: NVIDIA Corporation, Santa Clara, CA (US)

(21) Appl. No.: 11/776,567

(22) Filed: Jul. 12, 2007

(51) Int. Cl. G06F 3/048

(52) U.S. Cl. 715/765

(57) ABSTRACT

An aspect of the present invention simplifies management of icons by enabling a user to indicate that a first icon is to be merged with a second icon and displaying a third icon, where the third icon is different from each of the first and the second icons. The user may optionally de-merge the icons. In an embodiment, each of the constituent icons are designed to display the output of a program of a gadget.

### BACKGROUND

1. Field of Disclosure

The present disclosure relates generally to display interfaces and more specifically to management of icons in a display interface.

2. Related Art

Display interface generally refers to an output interface which is visually presented on a display screen of a computing system. The resulting display may have text, graphics, etc., as is well known in the relevant arts.

Icons are portions on a display interface, which when clicked on (using input devices such as a mouse, a touch pad, etc,) causes an associated action to be performed. The specific action performed may be determined based on aspects such as the number/frequency of clicking, the sub-portion of the icon on which the user clicks on, etc. The action may be showing the icon with a different display to indicate that the icon has been selected, ‘opening’ the icon into a large window, etc., depending on the requirements and design associated with the icon.

One of the challenges in management of icons is providing users the ability to arrange various icons of interest on a display interface.

### BRIEF DESCRIPTION OF THE DRAWINGS

Example embodiments will be described with reference to the following accompanying drawings, which are described briefly below.

FIG. 1 is a block diagram of a digital processing system illustrating an example embodiment in which several aspects of the present invention may be implemented.

FIG. 2 is a flowchart illustrating the manner in which management of icons of a display interface is simplified in an embodiment of the present invention.

FIGS. 3A-3C illustrate an example user experience in facilitating merger of icon in an embodiment.

FIG. 3D is a diagram illustrating an icon representing three merged icons in one embodiment.

FIG. 4 is a block diagram illustrating an example operating environment in which simplifying management of icons of a display interface is implemented in one embodiment.

FIG. 5 is a flowchart illustrating the manner in which an implementation in a digital processing system facilitates merger and de-merger of icons in one embodiment of the present invention.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

Overview

An aspect of the present invention simplifies management of icons by enabling a user to indicate that a first icon is to be merged with a second icon. A third icon may be displayed instead of the first and second icons, with the third icon being visually different from each of the first and the second icons.

Due to such a feature a user may be able to reduce the space required on a display interface and/or reduce the count of icons appearing on the display interface at a given time instance.

According to another aspect of the present invention, such a merger is facilitated with respect to icons which are part of gadgets. Each gadget may be viewed as containing a program and at least one corresponding icon. The program executes to generate dynamic content, which is then displayed in the corresponding icon. Gadgets are often used to implement utilities such as clock, news reader, weather reporter, etc. In the case of Windows Vista™ environment, the gadgets are provided on a sidebar or the desktop of a display interface.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well known structures or operations are not shown in detail to avoid obscuring the features of the invention.

Example Environment

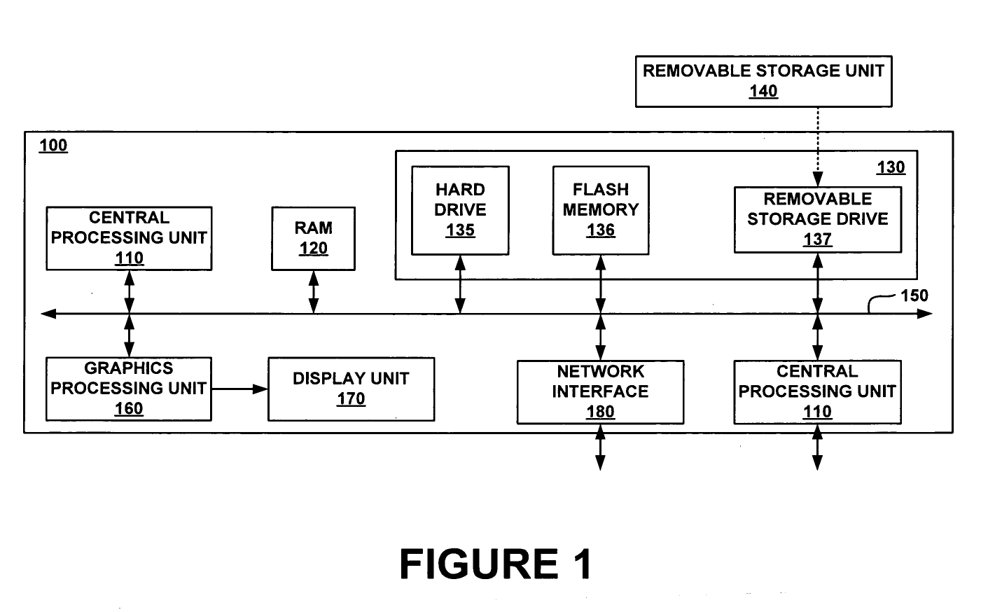

FIG. 1 is a block diagram illustrating the details of digital processing system 100 in which various aspects of the present invention are operative by execution of appropriate software instructions. The example environment is shown containing only representative systems for illustration. However, real-world environments may contain more/fewer/different systems/components as will be apparent to one skilled in the relevant arts. Implementations in such environments are also contemplated to be within the scope and spirit of various aspects of the present invention.

Digital processing system 100 may contain one or more processors (such as a central processing unit (CPU) 110), random access memory (RAM) 120, secondary memory 130, graphics controller 160, display unit 170, network interface 180, and input interface 190. All the components except display unit 170 may communicate with each other over communication path 150, which may contain several buses as is well known in the relevant arts. The components of FIG. 1 are described below in further detail.

CPU 110 may execute instructions stored in RAM 120 to provide several features of the present invention. CPU 110 may contain multiple processing units, with each processing unit potentially being designed for a specific task. Alternatively, CPU 110 may contain only a single general purpose processing unit. RAM 120 may receive instructions from secondary memory 130 using communication path 150.

Graphics Processor Unit (GPU) 160 generates display signals (e.g., in RGB format) to display unit 170 based on data/instructions received from CPU 110. Display unit 170 contains a display screen to display the images defined by the display signals. The images displayed on the display screen form the basis for various user interface features provided according to various aspects of the present invention described below.

Input interface 190 may correspond to a keyboard and a pointing device (e.g., touch-pad, mouse), which can be used to specify various user actions (click on, move, etc.) described below. Network interface 180 provides connectivity to a network (e.g., using Internet Protocol), and may be used to communicate with other connected systems (such as other digital processing systems, mobile phones/devices etc.).

Secondary memory 130 may contain hard drive 135, flash memory 136, and removable storage drive 137. Secondary memory 130 may store the data and software instructions, which enable digital processing system 110 to provide several features in accordance with the present invention.

Some or all of the data and instructions may be provided on removable storage unit 140, and the data and instructions may be read and provided by removable storage drive 137 to CPU 110. Floppy drive, magnetic tape drive, CD-ROM drive, DVD Drive, Flash memory, removable memory chip (PCMCIA Card, EPROM) are examples of such removable storage drive 137.

Removable storage unit 140 may be implemented using medium and storage format compatible with removable storage drive 137 such that removable storage drivel 37 can read the data and instructions. Thus, removable storage unit 140 includes a computer readable storage medium having stored therein computer software and/or data. However, the computer (or machine, in general) readable storage medium can be in other forms (e.g., non-removable, random access, etc.).

In this document, the term “computer program product” is used to generally refer to removable storage unit 140 or hard disk installed in hard drive 135. These computer program products are means for providing software to digital processing system 100. CPU 110 may retrieve the software instructions, and execute the instructions to provide various features of the present invention described below.

Various aspects of the present invention enable simplifying management of icons of a display interface as described with examples in subsequent sections.

Management of Icons of a Display Interface

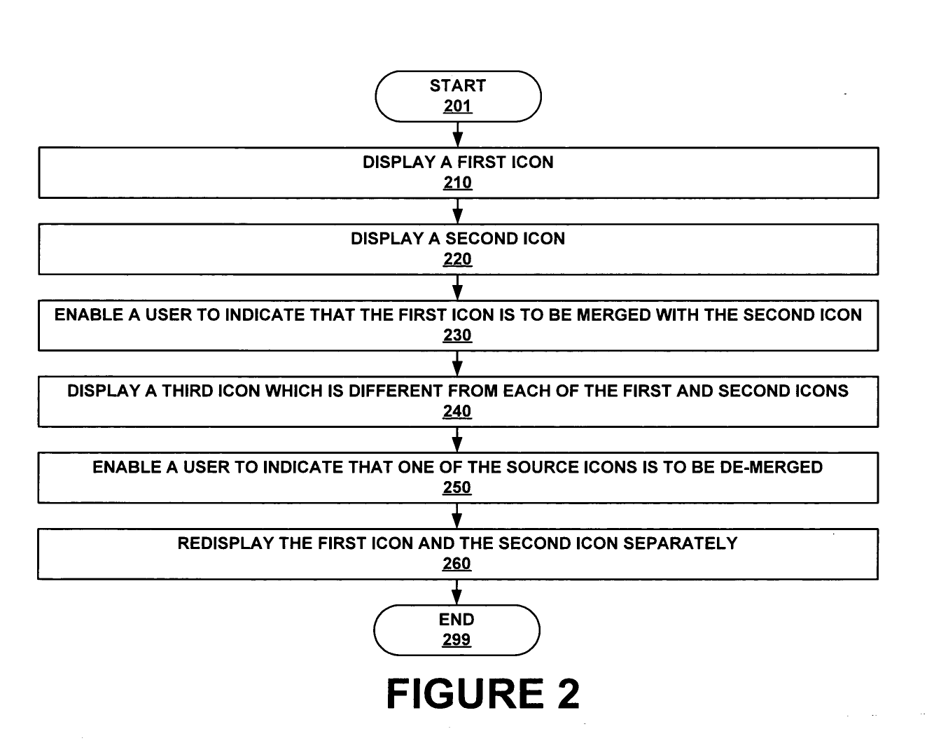

FIG. 2 is a flowchart illustrating the manner in which icons of a display interface can be managed in an embodiment of the present invention. The flowchart is described with respect to FIG. 1, merely for illustration. However, various features can be implemented in other environments and other components. Furthermore, the steps are described in a specific sequence merely for illustration.

Alternative embodiments in other environments, using other components, and different sequence of steps can also be implemented without departing from the scope and spirit of several aspects of the present invention, as will be apparent to one skilled in the relevant arts by reading the disclosure provided herein. The flowchart starts in step 201, in which control passes immediately to step 210.

In step 210, CPU 110 displays a first icon. The first icon uses a portion of a display to display various content, for example the output of a program (such as calculators, processor parameter displays, sticky notes, news readers, a program providing at a glance status of a number of instant Messaging contacts etc.) in case of gadgets. Such a display may contain text, graphics or both, etc. The display may be generated by one of several known ways.

In step 220, CPU 110 displays a second icon on a corresponding portion of the display interface. Step 220 may be performed similar to step 210.

In step 230, CPU 110 enables a user to indicate that the first icon is to be merged with the second icon. CPU 110 evaluates the inputs from a user to determine whether the user has indicated that the first icon is to be merged with the second icon. The user may use any of the input devices such as a keyboard or a pointing device to indicate that the first icon is to be merged with the second icon according to any pre-specified convention. In an embodiment, a user may use a pointing device (for example a mouse) to drag the first icon and drop it on the second icon to indicate that the first icon is to be merged with the second icon. However other alternative approaches such as using other input devices/mechanisms may be used for the indication.

In step 240, CPU 110 displays a third icon which is visually different from each of the first and second icons. For convenience, the third icon is referred to as a merged icon and the first/second icons of above are referred to as source icons. In general, the third icon can be of any design, but may conveniently be designed to indicate that multiple icons have been merged. It is further desirable that the user be able to operate with either of the gadgets, in case of the icons representing gadgets since the user may wish to view the dynamic content generated by the program content of the gadgets.

In step 250, CPU 110 enables a user to indicate that one of the source icons (assuming the first icon, for illustration) is to be de-merged from the merged icon. CPU 110 evaluates the inputs from a user to determine whether the user has indicated that the first icon (which is a merged entity of a first icon and a second icon) is to be de-merged. As with merger described above, any input device can be used to indicate the de-merger request and the de-merger can also be according to any pre-specified convention.

In step 260, CPU 110 redisplays the first icon and the second icon separately. Once CPU 110 determines (in step 250) that the merged icon is to be de-merged, the first icon and the second icon (both of which were merged to form the merged third icon) are displayed separately, with the form and content that existed before the merger. The flowchart ends in step 299.

While the description above is provided with respect to merger of only two icons/gadgets, for illustration, it should be appreciated that more than two icons can be merged into a single icon.

The merger and de-merger noted above can be implemented while providing various user interfaces, without departing from the scope and spirit of several aspects of the present invention, as will be apparent to one skilled in the relevant arts by reading the disclosure provided herein. The description is continued with an example user experience.

Example User Experience

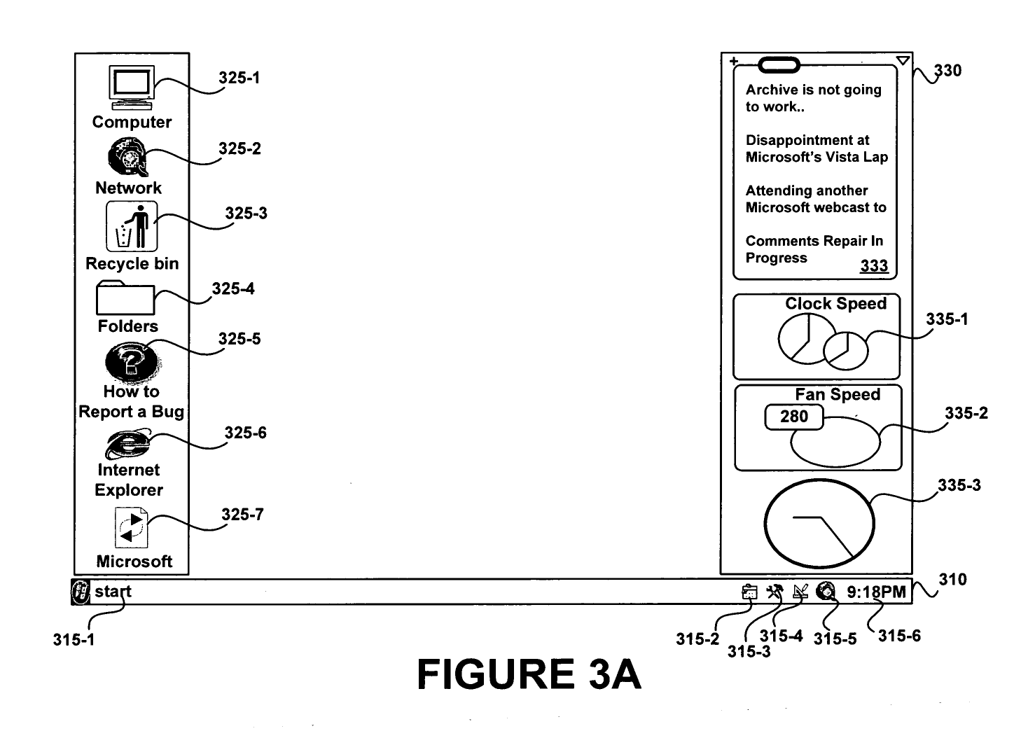

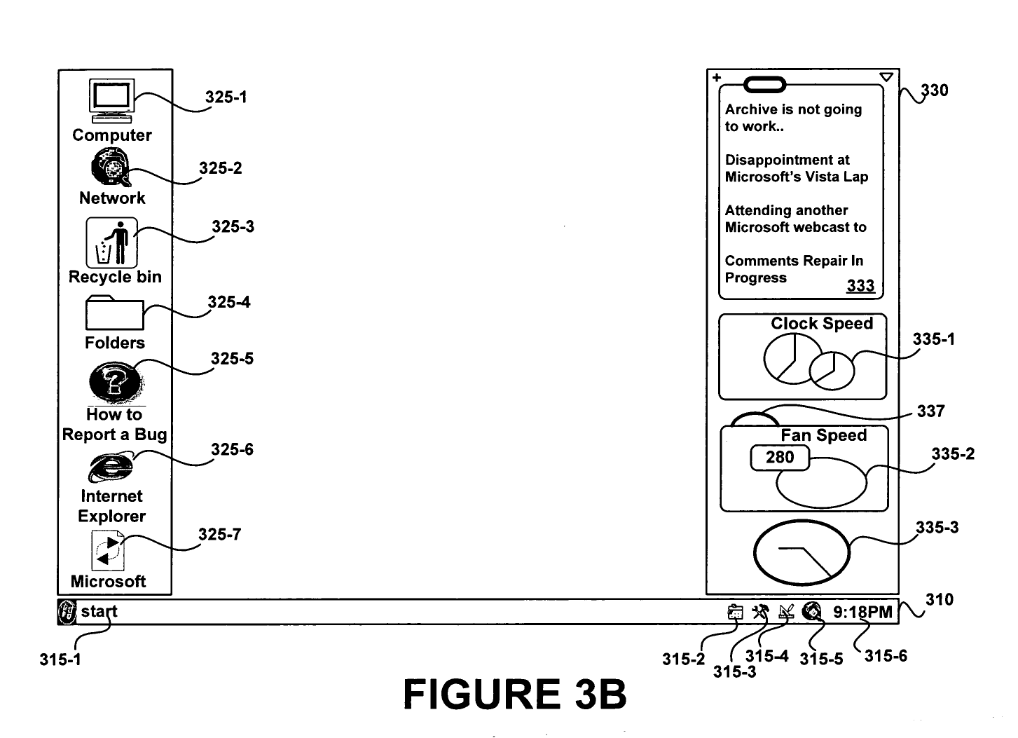

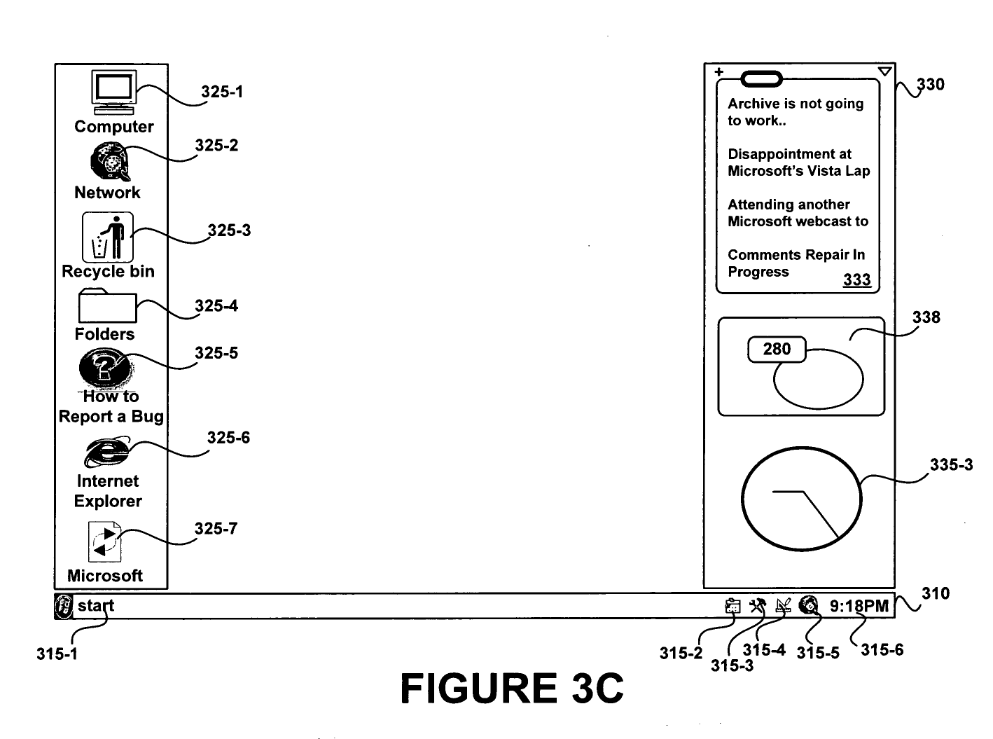

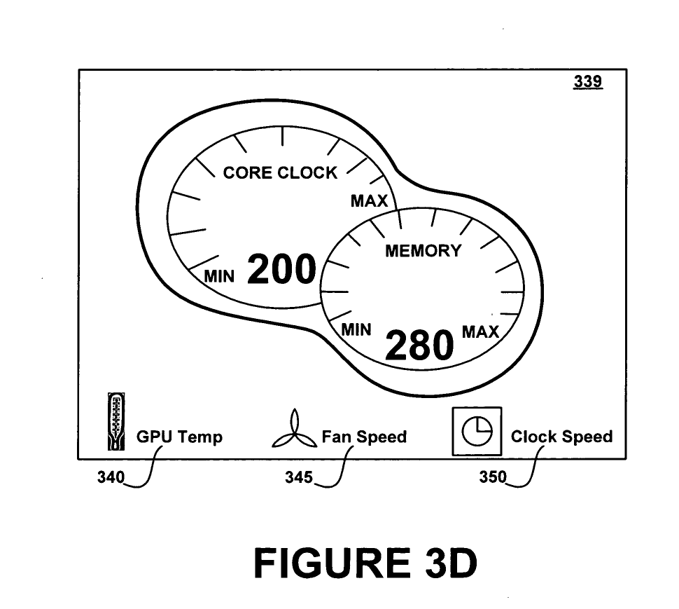

FIGS. 3A-3D contain a sequence of displays depicting an example user experience in an embodiment of the present invention. Merely for illustration, the icons are chosen to be gadgets and are shown arranged on a side-bar of a desk-top displayed on a computer system. The display there corresponds to a display generated by Windows Vista™ operating system provided by Microsoft Corporation and is described in further detail in a document entitled, “Windows Sidebar Gadgets” available from Microsoft Corporation and also at the URL: http://msdn2.microsoft.com/en-us/library/aa974179.aspx.

As described there, in an embodiment, gadgets in that environment are generally implemented (mini-) applications that give users fast access to personally relevant information and simple tasks—without getting in the way. For example, a weather gadget provides information that is available at a glance, and a notes gadget provides simple functionality used often in a typical day.

Gadgets in that environment are normally hosted in the Sidebar, which is a region on the side of the desktop. Besides being attached to, or docked, in the Sidebar, gadgets can also be detached from the Sidebar to float anywhere on the desktop. A gadget can be bigger in its floating state than in its docked state. Gadgets are part of the desktop, like the Start button, taskbar, and notification area. Unlike normal windows, they aren't represented with a taskbar button.

Gadgets in that environment can have flyouts that temporarily show more information. Flyouts are displayed by clicking the gadget, and dismissed by clicking anywhere outside the flyout. One can use flyouts in both the docked and floating states.

Gadgets can have an options dialog box for settings and customization.

FIG. 3A shows a desk-top display with a horizontal portion 310 at the bottom with icons 315-1 to 315-6 representing programs, a first vertical portion 320 on the left side with a icons 325-1 to 325-7 representing short cuts to folders, documents and programs, and a second vertical portion 330 (side-bar) on the right with icons 333 and 335-1 to 335-3 all of which display the output of respective programs.

Icon 333 displays the output of a program to receive RSS feeds, icon 335-1 displays a graphical representation and numerical values of the clock speeds of a processor core and a memory respectively, icon 335-2 displays a fan speed and icon 335-3 displays a clock.

In an embodiment, implemented under Windows Vista environment of Microsoft Corporation, vertical portion 330 is named as “sidebar”. As there may be many gadgets being used and the area in the sidebar is restricted, it is desirable to organize the corresponding icons on the sidebar. For example, the processor/memory clock speed icon 335-1 and the fan speed icon 335-2 are related and so may be grouped together.

As noted above, the icons corresponding to gadgets may be grouped together by merging them. A user may drag a mergeable icon using a pointing device (for example a mouse) on to a second mergeable icon and drop it to merge the two icons. The merger if icons may be viewed as a merger of gadgets, though the respective programs may continue to operate independently in the background without change. The outputs of all the programs may not be displayed in the merged state, as described below.

After merger, the resultant gadget (named super gadget to distinguish it from other gadgets which are not merged) displays substantial portions of one of the gadgets merged and provides navigation cues for switching to displaying substantial portions of the other gadget, as described below.

It may be appreciated that while the above description has been provided with respect to merging of two gadgets resulting in a super gadget, more mergeable gadgets may be merged with a super gadget to create super gadgets containing multiple mergeable gadgets.

FIG. 3B shows mergeable gadget 335-2 being dragged towards mergeable gadget 335-1. A group of semicircles of decreasing size give a visual cue 337 to the presence of mergeable gadget 335-1 in the direction suggested by visual cue 337 (from the larger semi circle to the smaller semi circle). This visual cue is presented when a mergeable gadget which is being dragged, reaches within a predefined distance of mergeable gadgets and serves to visually indicate to the user the mergeable gadgets is in the vicinity of the gadget being dragged. The user may then drop the mergeable gadget being dragged on to one of the mergeable gadgets indicated, to merge them.

FIG. 3C shows the merged gadget (super gadget) 338 which has replaced the gadgets 335-1 and 335-2 and visually represents a merger of gadgets 335-1 and 335-2. Super gadget 338 displays substantial portion of gadget 335-2 and shows navigation cues at the bottom of the super gadget in the form of tabs. By clicking on the appropriate tab, a user may switch the display of the super gadget to show the output of the corresponding constituent (original) gadget.

FIG. 3D shows a super gadget 339 which is formed by merging 3 gadgets, as indicated by the navigation tabs 340, 345 and 350. It is to be appreciated that more gadgets may be merged with a super gadget, as will be apparent to a person skilled in the relevant arts by reading the disclosure provided herein.

While FIGS. 3A-3D illustrate the merger of three icons/gadgets, it should be appreciated that the de-merger can be provided using a similar interface. For example, a user may merely drag the text representing a desired constituent gadget/icon (e.g., GPU temp 340 of FIG. 3D) out of the merged icon to de-merge the constituent gadget from the merged icon.

It should be appreciated that the approaches described above may be implemented in various operating environments. The description is continued with respect to implementation in an example operating environment.

Example Operating Environment

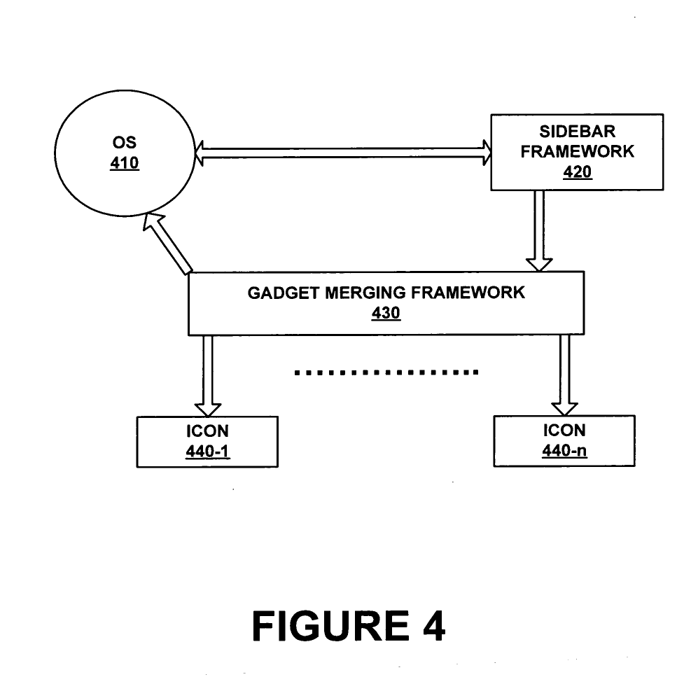

FIG. 4 is a block diagram illustrating an example operating environment in which simplifying management of icons of a display interface is implemented in one embodiment. The operating environment of FIG. 4 is shown containing operating system (OS) 410, Sidebar Framework 420, Gadget Merging Framework 430 and Icons 440-1 to 440-n.

Operating system 410 refers to an executing entity which facilitates access of various resources to applications 420 and 430 and icons 440-1 to 440-n. In general, when device 100 is initialized, control is transferred to operating system 410, which then facilitates execution of various user applications. In an embodiment, operating system 410 corresponds to Windows Vista operating system provided by Microsoft Corporation.

Sidebar framework 420 may also be packaged as a part of operating system 410, and enables an identified portion of a display to be used for displaying various icons as well as supporting configuration options and management of the icons. For example, in the Windows Vista operating system, the sidebar framework provides a sidebar which is an area of the display set apart for displaying icons corresponding to gadgets, as well as the functionality to manage the gadgets and their configuration.

Icons 440-1 to 440-n represent mergeable icons (icons which are designed to have the capability to be merged together) as noted above. For example, in the Windows Vista operating system, the icons 440-1 to 440-n represent gadgets with the capability of being merged (according to an aspect of the present invention) with other gadgets.

Gadget merging framework 430 provides the functionality for recognizing an indication that two mergeable icons are to be merged, displaying an icon which is formed by a merger of the two mergeable icons, recognizing that the merged icon is to be de-merged and redisplaying the constituents of the merged icon as separate icons, for example, as described above with respect to FIGS. 3A-3D.

In general, gadget merging framework 430 needs to be implemented consistent with the other components of the environment to facilitate merging and de-merging operations described above. In certain environments where the interfaces (e.g., by way of pre-specified procedure calls, etc.) are exposed for other programmers to use, one may study such interfaces in devising implementations consistent with the exposed interfaces. Such implementations will generally be apparent to skilled practitioners based on the exposed interfaces.

However, the description is continued with respect to the general logic underlying gadget merging framework in example embodiments.

Gadget Merging Framework

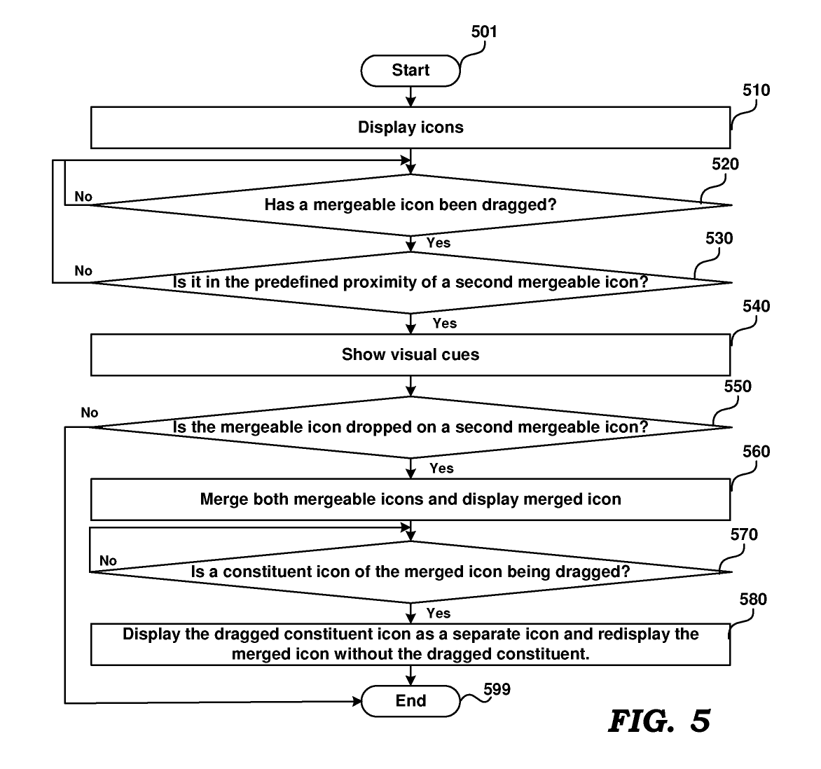

FIG. 5 is a flowchart illustrating the manner in which gadget merging framework may be implemented in an embodiment of the present invention. The description is provided assuming that CPU 110 causes the steps of the flowchart to be performed, for example, in response to execution of appropriate software instructions retrieved from the computer readable storage medium shown in FIG. 1.

The flowchart is described with respect to FIGS. 1-4 merely for illustration. However, various features can be implemented in other environments and other components. Furthermore, the steps are described in a specific sequence merely for illustration. Alternative embodiments in other environments, using other components, and different sequence of steps can also be implemented without departing from the scope and spirit of several aspects of the present invention, as will be apparent to one skilled in the relevant arts by reading the disclosure provided herein. The flowchart starts in step 501, in which control passes immediately to step 510.

In step 510, CPU 110 displays icons. It may be appreciated that the icons may have different properties, for example always on top or hidden etc. CPU 110 displays the icon as per the current set of properties for the icons.

In step 520, CPU 110 checks whether a mergeable icon has been dragged based on signals received from sidebar framework 430. A mergeable icon is an icon which has been designed such that it can be merged with another mergeable icon, as noted before. A user may use a pointing device to drag an icon, as described above. In an embodiment, the icons are gadgets under Windows Vista environment, as noted in section 5 above. In an example embodiment, mergeable icons are mergeable gadgets, i.e. gadgets designed such that they can be merged with another mergeable gadget.

For example, in an embodiment, the WM_MOVE event (details of which are available from Microsoft Corporation documentation or web page at http://msdn2.microsoft.com/en-us/library/ms632631.aspx) under Vista environment may be used by CPU 110 to check if a gadget is being dragged and CPU 110 may use configuration information related to a gadget to check if it is mergeable. If a mergeable icon is being dragged, processing continues to step 530. If not, control passes to step 520.

In step 530, CPU 110 checks whether a mergeable icon being dragged is in the predefined proximity of a second mergeable icon. The predefined proximity defines a distance (generally in terms of pixels) from the boundary of the second mergeable icon. If it is in the predefined proximity of the second mergeable icon, processing continues to step 540. Otherwise, control goes back to step 520.

In step 540, CPU 110 shows visual cues 337. The cues are generally shown by incorporating the appropriate data in the image frames eventually rendered on the display screens. Visual cues are shown close to the mergeable icon being dragged to indicate the presence and approximate location of other mergeable icons in the predefined proximity. The visual cues may help users to identify mergeable icons in the vicinity, on which the mergeable icon being dragged may be dropped, to merge them.

In step 550, CPU 110 checks whether the mergeable icon is dropped on a second mergeable icon. Only mergeable icons (which have been designed to be merged with other mergeable icons) can be merged together. In an embodiment, under the Windows Vista environment, CPU 110 may use WM_CAPTURECHANGED notification (details of which are available from Microsoft Corporation documentation or web page at http://msdn2.microsoft.com/en-us/library/ms645605.aspx) to check whether the mergeable icon (e.g., 335-2) has been dropped on another icon (335-1) and use configuration information related to the target icon to check whether it is a mergeable icon.

If the mergeable icon is dropped on a second mergeable icon, processing continues to step 560. If the mergeable icon is not dropped on a mergeable icon, processing continues to step 599.

In step 560, CPU 110 merges both mergeable icons and displays a merged icon. The merged icon may be formed in a number of ways, as described for step 240 of FIG. 2. In an embodiment, the merged entity is formed out of two mergeable gadgets and is referred to as a super gadget, as noted above. The super gadget has navigation cues displayed which may be used to select the content to be displayed, as described for FIGS. 5C and 5D.

In step 570, CPU 110 checks whether display portion (e.g., fan speed 345) corresponding a constituent icon of the merged icon is being dragged. The merged icon is formed out of mergeable icons. A user may drag a constituent icon using a pointing device to point at the display area of the merged icon displaying the respective constituent icon or at the respective navigation cue or other methods well known in the arts and dragging it. In an embodiment under the Windows Vista environment, a constituent gadget of the super gadget may be dragged away from the super gadget using a mouse or other pointing devices. If a constituent icon is being dragged, control passes to step 580. If not, control goes back to step 570.

In step 580, CPU 110 displays the dragged constituent as a separate icon and redisplays the merged icon without the dragged constituent. In an embodiment, under the Windows Vista framework, the gadget which is dragged away from the super gadget will be displayed separately and the super gadget will be redisplayed without the constituent gadget which was dragged away and any navigation cues corresponding to it. The flowchart ends in step 599.

It should be appreciated that the various features described with respect to FIGS. 2-5 above can be implemented as a combination of one or more of hardware, software and firmware. At least some of the features may be operative when appropriately designed software instructions are executed, as noted above with respect to FIG. 1.

### CONCLUSION

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A method of simplifying management of icons, said method comprising:
displaying a first icon and a second icon;
receiving an indication that said first icon is to be merged with said second icon; and
displaying a third icon in response to receiving said indication, wherein said third icon is visually different from each of said first icon and said second icon.

2. The method of claim 1, wherein said first icon is associated with a first gadget and said second icon is associated with a second gadget, wherein said first gadget comprises a first program which generates output displayed in said first icon and said second gadget comprises a second program which generates output displayed in said second icon.

3. The method of claim 2, wherein said third icon contains a first portion and a second portion, said method further comprising:
receiving a second indication indicating that said user has selected one of said first gadget and said second gadget using said first portion; and
displaying the icon corresponding to the selected gadget in said second portion in response to receiving said second indication.

4. The method of claim 3, wherein each of said first gadget and said second gadget are identified by a first text and a second text respectively, said method further comprising:
displaying said first text in a first sub-portion and said second text in a second sub-portion, wherein said first sub-portion and said second sub-portion are contained in said first portion.

5. The method of claim 2, wherein said first icon, said second icon and said third icon are all located on a side-bar of a desk-top display.

6. The method of claim 2, further comprising:
receiving another indication indicating that said second gadget is to be de-merged from said third icon; and
reverting back to displaying said first icon and said second icon individually in response to receiving said another indication.

7. A machine readable storage medium storing one or more sequences of instructions for causing a system to simplify management of icons, wherein execution of said one or more sequence of instructions by one or more processors contained in said system causes said system to perform the actions of:
displaying a first icon and a second icon;
receiving an indication that said first icon is to be merged with said second icon; and
displaying a third icon in response to receiving said indication, wherein said third icon is visually different from each of said first icon and said second icon.

8. The computer readable medium of claim 7, wherein said first icon is associated with a first gadget and said second icon is associated with a second gadget, wherein said first gadget comprises a first program which generates output displayed in said first icon and said second gadget comprises a second program which generates output displayed in said second icon.

9. The computer readable medium of claim 8, wherein said third icon contains a first portion and a second portion, further comprising:
receiving a second indication indicating that said user has selected one of said first gadget and said second gadget using said first portion; and
displaying the icon corresponding to the selected gadget in said second portion in response to receiving said second indication.

10. The computer readable medium of claim 9, wherein each of said first gadget and said second gadget are identified by a first text and a second text respectively, further comprising:
displaying said first text in a first sub-portion and said second text in a second sub-portion, wherein said first sub-portion and said second sub-portion are contained in said first portion.

11. The computer readable medium of claim 8, wherein said first icon, said second icon and said third icon are all located on a side-bar of a desk-top display.

12. The computer readable medium of claim 8, further comprising:
receiving another indication indicating that said second gadget is to be de-merged from said third icon; and
reverting back to displaying said first icon and said second icon individually in response to receiving said another indication.

13. The computer readable medium of claim 8, wherein said instructions are designed for execution in Windows Vista environment.

14. An apparatus for simplifying management of icons in a digital processing system, said apparatus comprising:
means for displaying a first icon and a second icon;
means for receiving an indication that said first icon is to be merged with said second icon; and
means for displaying a third icon in response to receiving said indication, wherein said third icon is visually different from each of said first icon and said second icon.

15. The apparatus of claim 14, wherein said first icon is associated with a first gadget and said second icon is associated with a second gadget, wherein said first gadget comprises a first program which generates output displayed in said first icon and said second gadget comprises a second program which generates output displayed in said second icon.

16. The apparatus of claim 15, wherein said third icon contains a first portion and a second portion, said apparatus further comprising:
means for receiving a second indication indicating that said user has selected one of said first gadget and said second gadget using said first portion; and
means for displaying the icon corresponding to the selected gadget in said second portion in response to receiving said second indication.

17. The apparatus of claim 16, wherein each of said first gadget and said second gadget are identified by a first text and a second text respectively, said apparatus further comprising:
means for displaying said first text in a first sub-portion and said second text in a second sub-portion, wherein said first sub-portion and said second sub-portion are contained in said first portion.

18. The apparatus of claim 15, wherein said first icon, said second icon and said third icon are all located on a side-bar of a desk-top display.

19. The apparatus of claim 15, further comprising:
means for receiving another indication indicating that said second gadget is to be de-merged from said third icon; and
means for reverting back to displaying said first icon and said second icon individually in response to receiving said another indication.
